(19) United States
(12) Patent Application Publication
(10) Pub. No.: US 2025/0301499 A1
(43) Pub. Date: Sep. 25, 2025

(54) METHODS AND APPARATUS FOR CO-CHANNEL COEXISTENCE

(71) Applicant: MediaTek Singapore Pte. Ltd., Singapore (SG)

(72) Inventors: Junqiang CHENG, Beijing (CN); Tao CHEN, Beijing (CN)

(21) Appl. No.: 18/860,241

(22) PCT Filed: Apr. 28, 2023
(86) PCT No.: PCT/CN2023/091801

§ 371 Date: Oct. 25, 2024

(30) Foreign Application Priority Data
May 6, 2022 (WO) PCT/CN2022/091192

(51) Int. Cl. H04W 74/0816

(52) U.S. Cl. CPC H04W 74/0816

(57) ABSTRACT

Apparatus and methods are provided for co-channel coexistence in the wireless network. In one novel aspect, the UE performs channel access before occupying one or more resources. In one embodiment, the SU UE determines a sensing configuration based on one or more preconfigured conditions, performs a channel access based on the sensing configuration, and transmits a cyclic prefix extension signal between an end position of the channel access success and a starting position of the SU transceiving only when the channel access is successful, otherwise, the UE performs a new channel access. In one embodiment, the sensing configuration includes one or more elements comprising a number of SU resources configured for SU transceivings, a number of sensing slots for channel sensing, an offset between a beginning of the SU resources, a triggering position of the channel sensing and a cyclic prefix extension starting position. In one embodiment, the sensing configuration is based on resource reservation information.

### TECHNICAL FIELD

The disclosed embodiments relate generally to wireless communication, and, more particularly, to co-channel coexistence in the wireless network.

### BACKGROUND

With the development and availability of 5G fast expanding worldwide, the demand of wireless data traffic is continually increasing. For future 5G advanced and 6G wireless communications, the spectrum sharing has the potential to address the continually increased demand of wireless data traffic. When a spectrum is shared or reused to another radio access technology (RAT) for a secondary usage (SU), the most critical issue is the harmonious co-channel coexistence between the secondary usage and the primary usage (PU), and thus should be addressed as a fundamental premise to ensure the secondary UEs can harmoniously reuse the frequency spectrum with the primary UEs. The current wireless network does not address the differences for primary users and secondary users. No step is taken to ensure the co-channel co-existence among users of different RAT for inter-RAT sharing nor intra-RAT sharing for secondary UEs.

Improvements and enhancements are required for co-channel coexistence in the wireless network.

### SUMMARY

Apparatus and methods are provided for co-channel coexistence in the wireless network. In one novel aspect, the UE of secondary usage (SU) performs channel access before occupying one or more resources. In one embodiment, the SU UE determines a sensing configuration based on one or more preconfigured conditions, performs a channel access based on the sensing configuration, and transmits a control signal between an end position of the channel access success and a starting position of the SU transceiving only when the channel access is successful, otherwise, the UE performs a new channel access. In one embodiment, the sensing configuration includes one or more elements comprising a number of SU resources configured for SU transceivings, a number of slots for channel sensing, and an offset between a beginning of the SU resources and a triggering position of the channel sensing. In another embodiment, the one or more sensing elements are configured by the network or generated by the UE. The one or more preconfigured conditions includes a frequency range of the transceiving resources, a numerology, a channel busy ratio, feedback information, a traffic type of the SU transceiving, a traffic priority of the SU transceiving, a channel access priority class (CAPC) of the SU transceiving, a 5G QoS identifier (5QI), and a PC5 QoS identifier (PQI). In one embodiment, the sensing configuration is based on resource reservation information. A random sensing configuration is determined when there is no reservation on the SU resource, a prioritized sensing configuration is determined when the SU resource is reserved by the UE, and a de-prioritized sensing configuration is determined when the SU resource is reserved by one or more other UEs. In one embodiment, control signal is a cyclic prefix (CP) extension (CPE) or timing advance (TA). In yet another embodiment, the determining of sensing configuration involves selecting a CPE starting position from a set of predefined CPE starting positions.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a schematic system diagram illustrating an exemplary wireless network for co-channel coexistence with UEs of primary usage and UEs of secondary usage in accordance with embodiments of the current invention.

FIG. 2 illustrates exemplary diagrams of co-channel coexistence for UEs of SU in accordance with embodiments of the current invention.

FIG. 3 illustrates exemplary diagrams of PU and SU UEs sharing a frequency spectrum with the US UEs performing channel sensing before data transceiving in accordance with embodiments of the current invention.

FIG. 4A illustrates exemplary diagrams of co-channel coexistence in view of time slots/symbols for PU and SU sharing with different channel sensing configuration for the SU in accordance with embodiments of the current invention.

FIG. 4B illustrates exemplary diagrams of different sensing slot configuration for co-channel coexistence in view of time slots/symbols in accordance with embodiments of the current invention.

FIG. 5 illustrates exemplary diagrams for SU prioritized channel access with reservation in accordance with embodiment of the current invention.

FIG. 6 illustrates exemplary diagrams for performing two-level channel access before occupying the resource to avoid intra-RAT collision for Su in accordance with embodiments of the current invention.

FIG. 7 illustrates an exemplary flow chart for the co-channel coexistence procedure for the SU UE in accordance with embodiments of the current invention.

### DETAILED DESCRIPTION

Reference will now be made in detail to some embodiments of the invention, examples of which are illustrated in the accompanying drawings.

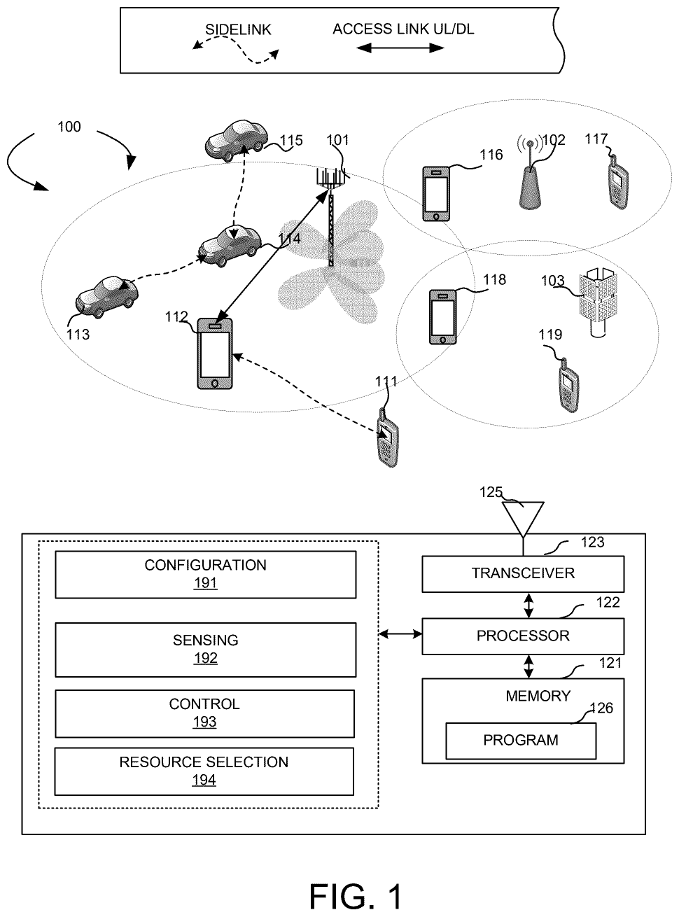

FIG. 1 illustrates a schematic system diagram illustrating an exemplary wireless network for co-channel coexistence with UEs of primary usage and UEs of secondary usage in accordance with embodiments of the current invention. Wireless network 100 includes multiple communication devices or mobile stations, such as user equipments (UEs) 111, 112, 113, 114, and 115, which operate in different RAT. Some of the exemplary mobile devices in wireless network 100 have sidelink capabilities. Sidelink communications refer to the direct communications between terminal nodes or UEs without the data going through the network. For example, UE 113 communicates with UE 114 directly without going through links with the network units. The scope of sidelink transmission also supports UE-to-network relay to extend the service range of an eNB, where the inter-coverage UE acts as the relay node between an eNB and an out-of-coverage UE. For example, UE 112 is connected with base station 101 through an access link. UE 112 provides network access for out-of-coverage UE 111 through sidelink relay. Some are configured as PU and some are configured as SU. For example, UE 112 is a cellular user, while UE 111, 113, 114, and 115 are configured as sidelink users. In one scenario, the cellular UE, such as UE 112, is configured as the PU. The sidelink communications, such as used by UE 111, 113, 114, and 115, are SU. In other scenarios, the cochannel co-existence methods applies to both licensed band and unlicensed bands. Mobile devices/UEs with different RATs also co-existence. For example, neighboring UEs 116 and 117 communicate with base station 102 through other RATs, such as Wi-Fi, sharing the same licensed or unlicensed frequency band. Neighboring UEs 118 and 119 communicate with base station 103 through other RATs, such as NR, sharing the same licensed or unlicensed frequency band. In another scenario, LTE-SU, such as UE 111, 113, 114, and 115 are configured as PU; while NR-SU, such as 118 and 119 are configured as SU.

The base station, such as base station 101, may also be referred to as an access point, an access terminal, a base station, a Node-B, an eNode-B (CNB), a gNB, or by other terminology used in the art. The network can be a homogeneous network or heterogeneous network, which can be deployed with the same frequency or different frequencies. Base station 101 is an exemplary base station.

In one novel aspect, an SU transceiving occupies one or more resources only there is no PU. The spectrum/resource is (pre-) configured to share with a secondary usage (SU). Specifically, for a secondary usage of a spectrum/resource, whenever the secondary UEs want to start a transmission(s) on the (pre-)configured spectrum/resource where the primary usage (PU) has already been deployed, the secondary UEs should always execute a channel access/sensing procedure before they can occupy the spectrum/resource for transmission on the current slot. The channel access/sensing procedure is a procedure based on sensing that evaluates the availability of a channel for performing transmissions. If the channel is evaluated to be idle during the channel access/sensing duration, the secondary UEs can occupy the current slot and start transmission. Otherwise, the secondary UEs cannot start transmission on the current slot, and they should wait for the next (pre-)configured resource for the secondary usage and perform the channel access/sensing procedure. In another novel aspect, a two-level and prioritized/deprioritized sensing mechanism can be (pre-)configured to avoid collisions among the secondary UEs and also a prioritized/deprioritized access order. For the case that sidelink (SL) is the secondary usage, the SCI sensing information can be used to find out the resources/slots reserved by the other SL UEs in the same RAT. Besides, within the channel access/sensing procedure, an energy detection sensing implementation can be executed by different SL UEs. For example, the duration of sensing slot, and/or the number of sensing slots, and/or the trigger time of the first sensing slot can be (pre) configured by the network or generated by the UE. Empower by the two-level and prioritized/deprioritized sensing mechanism proposed in this disclosure, the collisions on the resources with or without reservation can be avoid among the UEs in the secondary usage.

FIG. 1 further illustrates simplified block diagrams of a mobile device/UE for operating in the unlicensed frequency band. UE 111 is an example. UE 111 has an antenna 125, which transmits and receives radio signals. An RF transceiver circuit 123, coupled with the antenna, receives RF signals from antenna 125, converts them to baseband signals, and sends them to processor 122. In one embodiment, the RF transceiver may comprise two RF modules (not shown). RF transceiver 123 also converts received baseband signals from processor 122, converts them to RF signals, and sends out to antenna 125. Processor 122 processes the received baseband signals and invokes different functional modules to perform features in UE 111. Memory 121 stores program instructions and data 126 to control the operations of UE 111. Antenna 125 sends uplink transmission and receives downlink transmissions to/from base stations.

UE 111 also includes a set of control modules that carry out functional tasks. These control modules can be implemented by circuits, software, firmware, or a combination of them. A configuration module 191 determines a sensing configuration for a secondary usage (SU) transceiving in a wireless network, wherein the SU transceiving occupies one or more resources only when there is no primary usage (PU), and wherein one or more sensing elements of the sensing configuration is determined based on one or more predefined conditions. A sensing module 192 performs a first channel sensing based on the sensing configuration, wherein the channel sensing is successful when all slots being sensed are idle. A control module 193 transmits a control signal between an end position of a success of the first channel sensing and a starting position of the SU transceiving when the first channel sensing is successful, otherwise performs a second channel sensing for subsequent SU resources. A resource selection module that selects resource based on one or multiple channel access information.

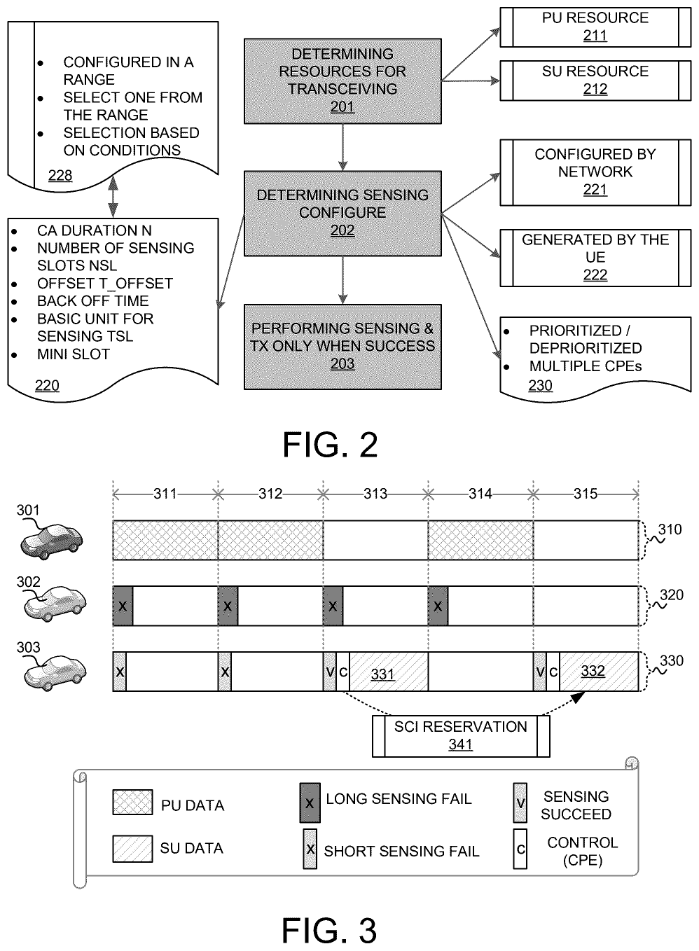

FIG. 2 illustrates exemplary diagrams of co-channel coexistence for UEs of SU in accordance with embodiments of the current invention. A wireless network is configured with shared resources, which has multiple RATs sharing the same resources. The resources are configured to be shared or reused by one or more other RATs for SU. In such a scenario, the most critical issue is the harmonious co-channel coexistence between the UEs in the secondary usage (secondary UEs) and the UEs in the primary usage (primary UEs). In one novel aspect, the UE operating in SU performs channel sensing before data transceiving. At step 201, the UE determines if one or more resources are for PU 211 or SU 212. In one embodiment, the resources are preconfigured or dynamically configured as PU resources 211 or SU resources 212. In another embodiment, the type of resource may also be configured as PU, SU or flexible. Whenever a resource is indicated to be shared with the UEs for a secondary usage by signaling or pre-configuration, the secondary UEs should always execute a channel access/sensing procedure before they can occupy the resource/slot. At step 202, the UE operating in SU determines a channel sensing configuration. The sensing configuration includes one or more sensing elements 220, including a number of SU resources configured for channel accessing procedure duration N, which is a number of symbols, a number of slots for channel sensing N_sl, and an offset between a beginning of the SU resources and a triggering position of the channel sensing T_offset. Sensing elements 220 further includes a number of back-off slots N_bo and a basic unit for sensing T_sl, and mini slot N_d between a channel access success and the data transceiving. In one embodiment 221, the one or more sensing elements are configured by the wireless network based on one or more preconfigured conditions. In another embodiment 222, the one or more sensing elements are generated by the UE based on one or more preconfigured conditions. In one embodiment 228, one or more of the sensing elements are determined based on corresponding sensing element range. Each sensing element range is either preconfigured or determined by the network or the UE based on one or more conditions. The UE or the network, selects a value within the sensing element range based on one or more conditions. The one or more predefined conditions includes the one or more predefined conditions comprise a frequency range of the transceiving resources, a numerology, a channel busy ratio, feedback information, a traffic type of the SU transceiving, a traffic priority of the SU transceiving, a channel access priority class (CAPC) of the SU transceiving, a 5G QoS identifier (5Q1), and a PC5 QoS identifier (PQI).

The channel access/sensing procedure can be executed within a (pre-)configured duration. For example, the channel access/sensing procedure can be (pre-)configured within N symbols at the beginning of or within the (pre-)configured/indicated slot(s) shared for secondary usage. The value of N can be (pre-) configured by the network or randomly generated by the UE from a channel access/sensing range/window [Nₘᵢₙ, Nₘₐₓ], which can be preconfigured by the network or generated by the UE based on one or more conditions, such as the frequency range, the numerology, the channel busy ratio, the ACK/NACK feedback information, the traffic type/priority, CAPC, 5QI, PQI, and the resource reservation information.

The UE in the secondary usage should execute channel access/sensing procedure as long as the channel access/sensing is started/triggered. The channel access/sensing procedure is configured with sensing slots. The value of sensing slots N_sl is configured by the network or randomly generated by the UE. In one embodiment, the UE randomly selects the number of sensing slot from a sensing slot range/window [N_{sl,min}, N_{sl,max}], which can be configured by the network or generated by the UE. The UE or the network generates the sensing slot range based on one or more conditions, such as, the value of N, the value of T_offset, the duration of sensing slot, the frequency range, the numerology, the channel busy ratio, the ACK/NACK feedback information, the traffic type, the traffic priority, CAPC, 5QI, PQI, and the resource reservation information. The channel access/sensing procedure is considered to be successful/idle if N_sl sensing slots are all sensed to be idle within the N symbols.

During the channel access/sensing procedure, the UE in the secondary usage triggers the channel access/sensing procedure at a specific position within the N symbols. The trigger time/position of the channel access/sensing procedure is determined by a parameter T_offset, which is the duration from the beginning of the configured/indicated slot for secondary usage to the triggering time/position of the channel access/sensing procedure (i.e., the starting position of the first sensing slot). The value of T_offset can be configured by the network or randomly generated by the UE. In one embodiment, the UE randomly selects the T_offset from an offset range/window [T_{offset,min}, T_{offset,max}], which can be configured by the network or generated by the UE. In one embodiment, the UE or the network generates the offset range based on one or more conditions including the value of N, the duration of the sensing slot, the frequency range, the numerology, the channel busy ratio, the ACK/NACK feedback information, the traffic type, the traffic priority, CAPC, 5QI, PQI, and the resource reservation information.

During the channel access/sensing procedure, a basic unit for sensing is a sensing slot with a (pre-)configured duration T_sl based on the numerology and/or frequency range. For example, the sensing slot T_sl can be (pre-)configured as 9 μs or 5 μs or other values based on different numerology. The sensing slot T_sl is considered to be idle if the UE in the secondary usage senses the channel during the sensing slot duration and determines that the detected power for at least T_al within the sensing slot duration is less than a (pre-)configured energy detection threshold XThresh. Otherwise, the sensing slot duration T_sl is considered to be busy. The value of Tal can be (pre-)configured for different sensing slot duration T_sl, for example, 4 μs for the sensing slot of 9 μs.

If the channel access/sensing procedure fails, the secondary UE cannot start transmission on the slot that is configured/indicated for a secondary usage. Instead, the secondary UEs should wait for the next resource configured/indicated for the secondary usage and perform a (new) channel access/sensing procedure. Moreover, the next resource for a secondary usage is configured with a consideration of back-off N_bo slots. N_bo is the duration of back-off in slot from the end of the current slot where the channel access/sensing is failed to the beginning of the slot where a new channel access/sensing can be executed. The value of N_bo is configured by the network or randomly generated by the UE. In one embodiment, the UE randomly selects the N_bo from a back-off range/window N_{bo,min}, N_{bo,max}. In one embodiment, the back-off range is configured by the network or generated by the UE. In one embodiment, the N_bo range is based on one or more conditions including the frequency range, the numerology, the channel busy ratio, the ACK/NACK feedback information, the traffic type/priority, CAPC, 5QI, and the PQI.

In one embodiment, a control signal is transmitted between and end position of a success of the channel sensing and a starting position of the SU transceiving. In one embodiment, the control signal is one or more selecting from a control CP extension (CPE), timing advance (TA), the data message, and other control message. The control signal is used to align the boundary between channel access/sensing successful position and data transmission position. And the secondary UE can start transmission on the following Nd symbols (i.e., mini-slot) within the slot shared for secondary usage, where N_d can be (pre-)configured based on, for example, the RAT type of the primary usage.

In one embodiment 230, the SU performs the channel sensing based on reservation information, which includes SU resource reservations by the UE and by one or more other UEs. The one or more sensing elements of 220 and the corresponding sensing range 230, when applicable, is selected based on the reservation information. If the resource reservation information can be used in the secondary usage (e.g., the sidelink technology), the secondary UEs will send/receive the resource reservation information to/from other secondary UEs. If there is no resource reservation information (e.g., before the resource for initial transmission), the secondary UEs should perform a fair/random channel access/sensing procedure with a random trigger time/position of the channel access/sensing procedure, i.e., T_offset, and a random number of sensing slot, i.e., N_sl as described above. If the resource/slot (pre-)configured/indicated for secondary usage is reserved by a secondary UE, this secondary UE can perform a prioritized channel access/sensing before the reserved resource/slot. For example, the trigger time/position of the channel access/sensing procedure T_offset of the prioritized channel access/sensing procedure can be (pre-)configured by the network or randomly generated by the UE from a smaller value of the offset range/window [T_{offset,min,s}, T_{offset,max,s}]. Besides, the number of sensing slot N_sl in the prioritized channel access/sensing procedure can be (pre-)configured by the network or randomly generated by the UE from a smaller value of the sensing slot range/window [N_{sl,min,s}, N_{sl,max,s}]. For the other secondary UEs not reserve the resource/slot, they should perform a de-prioritized channel access/sensing if they want to occupy the resource/slot reserved by another secondary UE. For example, the trigger time/position of the de-prioritized channel access/sensing procedure T_offset can be (pre-)configured by the network or randomly generated by the UE from a larger value of the offset range/window [T_{offset,min,l}, T_{offset,max,l}]. Besides, the number of sensing slot N_sl in the de-prioritized channel access/sensing procedure can be (pre-) configured by the network or randomly generated by the UE from a larger value of the sensing slot range/window [N_{sl,min,l}, N_{sl,max,l}]. The value of the smaller value of offset range/window, and/or the smaller value of the sensing slot range/window, and/or the larger value of the offset range/window, and/or the larger value of the sensing slot range/window can be (pre-)configured by the network or generated by the UE to guarantee the prioritized or de-prioritized channel access/sensing according to the resource reservation information.

Once the UE determines the sensing configuration, the UE performs the channel sensing at step 203. The SU UE only performs data transceiving when the channel access/sensing procedure is successful.

FIG. 3 illustrates exemplary diagrams of PU and SU UEs sharing a frequency spectrum with the US UEs performing channel sensing before data transceiving in accordance with embodiments of the current invention. UE 301, the PU UE, is a UE operating with PU with an exemplary transmission 310. UE 302 and 303, the SU UEs, are UEs operating with SU with exemplary transmission 320 and 330, respectively. UE 301, 302 and 303 share the same resources. Exemplary resource slots/resources 311, 312, 313, 314, and 315 are shared resources configured in the wireless network. In one embodiment, the PU UE occupies the resources without channel access procedure, while the SU UEs only occupy the resources upon channel access success. As an example, slots 311, 312 and 314 are used by PU UE 301. SU UEs 302 and 303 performs channel access for slots 311 and 312 before they occupy the slots. The channel access failed for both UE 302 and 303 since the resources are used by PU UE 301. In one embodiment, the resources are configured by the network as PU or SU. In another embodiment, the resources are configured as PU, SU or flexible. Subsequently, UE 302 and 303 both perform channel access for slot 313. UE 303 succeeds with the channel access and transmits a control signal at the end of the channel success. UE 303 performs data transceiving 331 for resource 313. UE 302, while performing the channel access, detects the control signal from UE 302 and fails the channel access. In one embodiment, the SU UE reserves a further resource. At step 341, UE 303 reserves a future resource 315. UE 303 sends messages to other UEs, such as UE 302 about the reservation. In one embodiment, UE 302 upon receiving the reservation message from UE 303, skips channel access procedure for resource 315. UE 303 performs a prioritized channel access for resource 315 and sending out a signal. UE 303 performs data transmission 332 on resource 315.

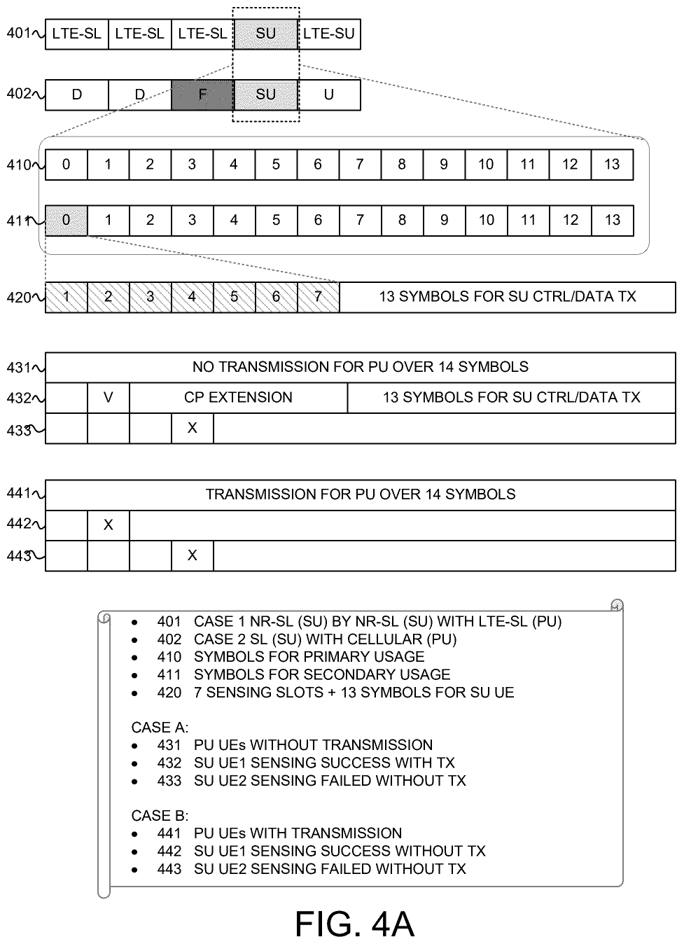

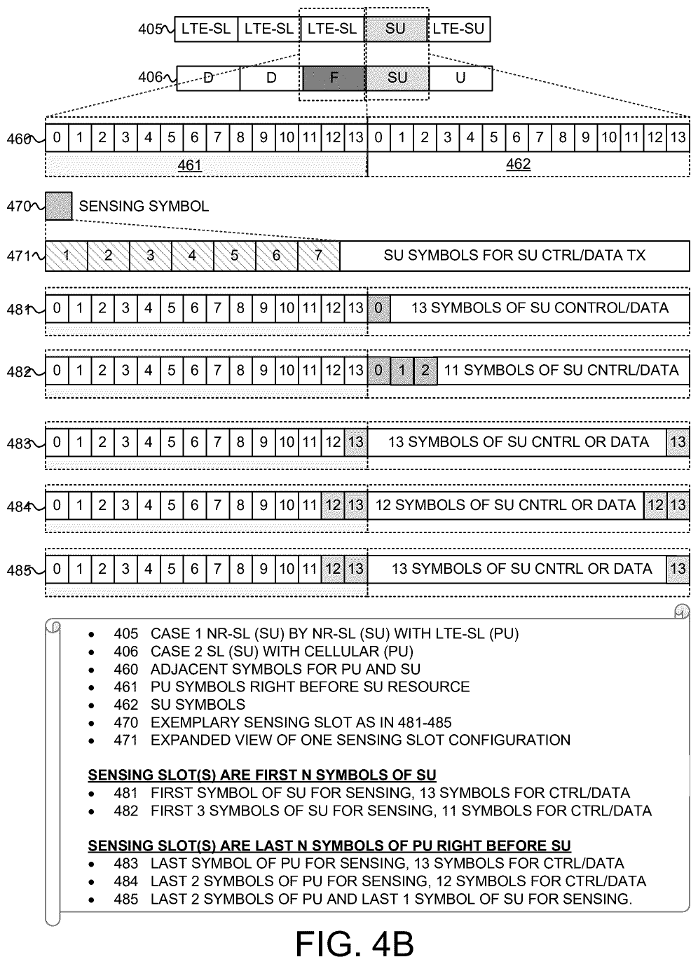

FIG. 4A illustrates exemplary diagrams of co-channel coexistence in view of time slots/symbols for PU and SU sharing with different channel sensing configuration for the SU in accordance with embodiments of the current invention. For exemplary case-1 401, LTE-SL is the primary usage (PU) while NR-SL (402) is the secondary usage (SU). The resources/slots are (pre-) configured/indicated to be used for LTE-SL or shared with NR-SL, noted as SU resources. For exemplary case-2 402, cellular communication is the primary usage while SL is the secondary usage. The resources/slots are configured/indicated to be used for cellular communication (e.g.,

DL, marked as “D” or UL), or flexible “F”, or shared with a secondary usage, marked as “SU”. For the resource/slot (pre-)configured/indicated for secondary usage in both cases, one example is that the resource/slot can be occupied for primary usage. In another embodiment, the resource/slot can be occupied for secondary usage if there is no transmission(s) from the primary UEs. If the secondary UEs intend to start transmissions on the resource/slot (pre-)configured for secondary usage, the channel access/sensing procedure should be executed by the secondary UEs to evaluate whether the resource/slot is idle or busy. For PU symbols 410, all the symbols are used to transceiving. For SU symbols 411, the channel access/procedure is configured within the first symbol of the slot for the secondary usage, i.e., N=1. In other embodiments, the last symbol of the SU slot is configured for channel sensing. The other thirteen symbols in this slot can be used for data transmission(s) of the secondary UEs if the channel access/procedure is successful. Specifically, as the example 420, the channel access/sensing procedure takes the first symbol of the SU slot, as in 411, and uses the first symbol for channel sensing. As an example, seven sensing slots are configured, each with a period of time. The seven sensing slots occupy the time of the first symbol of the SU slot with a trigger time at the beginning position of the first symbol. For case A, as shown with 431, 432 and 433, there are no transmissions from primary UEs 431 on the slot for secondary usage. In this case, for UE1 in the secondary usage 432, the channel access/sensing procedure is comprised of two sensing slots, i.e., N_sl=2. For UE2 in the secondary usage 433, the channel access/sensing procedure is comprised of four sensing slots, i.e, N_sl=4. For the reason that there is no transmission from primary UEs, the secondary UE1 will sense the channel to be idle within the two sensing slots. Therefore, the channel access/sensing procedures for secondary UE1 is successful after the two sensing slots, and the secondary UE1 will use a (pre-) configured CP extension to align the boundary between the channel access/sensing successful position (i.e., the ending position of the second sensing slot in the first symbol) and data transmission position (i.e., the beginning position of the second symbol in the slot). Then the secondary UE1 can start the transmission on the following 13 symbols within the current slot. In other cases, if the primary usage is cellular communication system, the last few symbols can be (pre-)configured for legacy PUCCH transmission. For the secondary UE2 in case A, its channel access/sensing procedure will fail when it encounters the CP extension from UE1. Therefore, the secondary UE2 cannot transmit on the following thirteen symbols in this slot, and it should wait for the next slot (pre-)configured/indicated for secondary usage and perform a (new) channel access/sensing procedure. For another example, case B as shown in 441, 442, and 443, the resource/slot (pre-)configured/indicated for secondary usage is occupied by the UEs in the primary usage with a transmission (441). In this case, the UE1 and UE2 in the secondary usage, 442 and 443, respectively, will both sense the channel to be busy during their channel access/sensing procedure, and thus both UE1 and UE2 cannot start their transmission on that resource/slot. Instead, both UE1 and UE2 should wait for the next resource/slot (pre-)configured/indicated for secondary usage and execute a (new) channel access/sensing procedure.

FIG. 4B illustrates exemplary diagrams of different sensing slot configuration for co-channel coexistence in view of time slots/symbols in accordance with embodiments of the current invention. In one embodiment, the one or more sensing symbols for channel sensing are the first N symbols of the SU slot. In another embodiment, the one or more sensing symbols for channel sensing are the last N symbols of the PU slot, which is adjacent to the SU slot. As an exemplary configuration 405 LTE-SL is the PU while NR-SL is the SU and configuration 406 cellular communication is the PU while SL is the SU. 460 illustrates an expanded view of the two adjacent slots of PU 461 and SU slot 462, each with 14 symbols. 470 is one exemplary sensing symbol, which can be one the first N symbols of the SU 462 or the last N symbols of the PU 461. In one exemplary, each sensing symbol has multiple sensing slots as in 471. If the channel sensing is successful, SU symbols for SU control and/or data transceiving are followed. In one configuration 481, the first one symbol of the SU slot is configured for channel sensing and the remaining 13 symbols are for SU control and/or data transceiving when the channel sensing succeeded. In another configuration 482, the first three symbols of the SU slot is configured for channel sensing and the remaining 11 symbols are for SU control and/or data transceiving when the channel sensing succeeded. In configuration 483, the last symbol of the adjacent PU slot is used for channel sensing. If the channel sensing succeeded, the symbols in SU slots are used for SU control and/or data transceiving. In this configuration, the last symbol of the SU slot is used for channel sensing for subsequent SU transceiving. In configuration 484, the last two symbols of the adjacent PU slot is used for channel sensing. If the channel sensing succeeded, the symbols in SU slots are used for SU control and/or data transceiving. In this configuration, the last two symbols of the SU slot are used for channel sensing for subsequent SU transceiving. In yet another embodiment, the number of sensing symbols in different slots are configured with different values. The sensing symbol number is preconfigured or dynamically determined based on one or more factors, including channel conditions, traffic type, reservation status and other UE metrics and/or configurations. As an example, configure 485 the last two symbols of the adjacent PU slot is used for channel sensing. If the channel sensing succeeded, the symbols in SU slots are used for SU control and/or data transceiving. In this configuration, the last one symbol of the SU slot is used for channel sensing for subsequent SU transceiving.

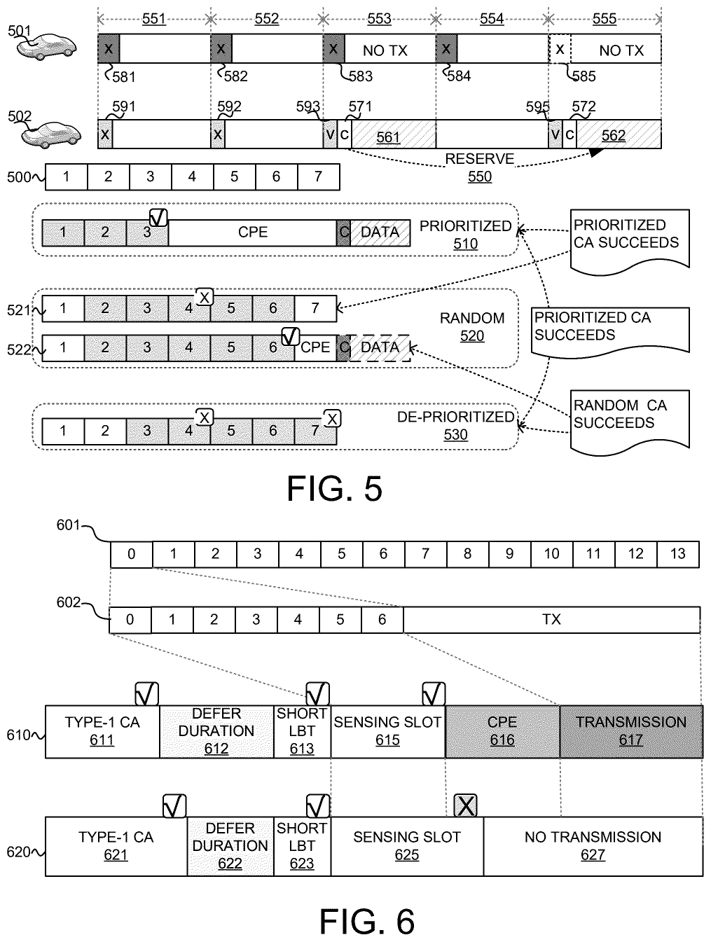

FIG. 5 illustrates exemplary diagrams for SU prioritized channel access with reservation in accordance with embodiment of the current invention. Two secondary UE pairs, UE 501, and UE 502, with SL pair-1 (SL-1) and SL pair-2 (SL-2), respectively, are going the start transmission on the resources/slots configured/indicated for secondary usage, SUs 551, 552, 553, 554, and 555. If there is no resource reservation information can be used, for example, at SU 551, 552 and 553, SL-1 and SL-2 should perform a random/fair channel access/sensing procedure. Channel access 581, 582, and 583 for UE 501 and 591, 592, and 593 for UE 502 are random channel procedures with corresponding random sensing configuration. The exemplary configuration 500 is for the channel sensing with seven symbols configured. Channel access 593, configured as random sensing configuration, was successful and control 571 is transmitted. UE 502 performs data transceiving 561 at resource 553 upon channel access success. In one embodiment, UE 502, at step 550, reserves future resource 555 through control message. In one embodiment, multiple levels of sensing configuration are used for SU channel accessing. In one embodiment, the sensing configuration has prioritized 510, random 520, and de-prioritized 530. For SL-1 or SL-2, the prioritized channel access/sensing procedure (510) is configured by the network or generated by SL-1 or SL-2 with T_offset=0 and N_sl=3. The random channel access 520 is configured with T_offset=1 and N_sl=5. The de-prioritized channel access 530 is configured T_offset=2 and

N_sl=5. After the successful channel access/sensing by SL-2 at 553, the SL-2 will send the resource reservation information to other secondary UEs. Then UE 502 can perform a prioritized channel access/sensing procedure before starting transmission on the reserved resource/slot, i.e., 555. As UE 502 reserved resource 555, only UE 501 performs channel access 584, which failed. With the resource reservation information sent from SL-2, SL-1 should perform a de-prioritized channel access/sensing procedure before it can start transmission on the resource/slot reserved/occupied by SL-2, i.e., SUS in the figure. For UE 501, the de-prioritized channel access/sensing procedure is (pre-) configure by the network or generated by SL-2with T_offset=2 and N_sl=5. For the channel access/sensing of the reserved resource/slot, the different level of prioritized or de-prioritized channel access/sensing can be configured by the network or generated by the UE to guarantee the prioritized access for the UE who reserved the corresponding resource/slot. When a UE with prioritized configuration 510 and another UE with random configure 521, the channel sensing for random configure 521 fails. When the random configured (522) UE and another with de-prioritized configuration 530, the channel sensing for the random configuration 522 succeeds. After prioritized channel access 595 succeeds, UE 502 sends control message 572 and performs SU transceiving 562. UE 501 may perform a deprioritized channel 585 at resource 555. Channel access 585 will fail if channel access 595 is performed. For the case that the resource reserved UE, i.e., SL-2, do not start transmission on the reserved resource, i.e., resource 555, the other secondary UEs, i.e., UE 501, can start the transmission on the reserved resource if the de-prioritized channel access/sensing perform by SL-1 is successful.

In one embodiment, the shared spectrum can be unlicensed spectrum. In this case, if the secondary UEs are operated in a very low power (e.g., 14 dBm) mode, the secondary UEs can be (pre-) configured to start transmission on the resource(s)/slot(s) without performing channel access/sensing procedure. In another embodiment, the resource(s)/slot(s) after a successful channel access/sensing can be shared to the other UEs as (pre-) configured, i.e., COT sharing. In this case, the UE who intends to access the shared COT (COT sharing UEs) should first send its buffer status information/report (BSR) as long as they have packet to transmit or as long as the communication group is set up. Then for the UE who finish a successful channel access/sensing (COT initiator UE), it can send the COT sharing information to the other UEs. Moreover, the COT initiator UE can also send the channel access/sensing grant information (e.g., the trigger time and/or the sensing slot number, etc.) to the COT sharing UE(s) based on one or more conditions including the BSR, the traffic priority, CAPC, 5QI of the COT sharing UE, PQI of the COT sharing UE, the channel busy ratio, and the ACK/NACK feedback. FIG. 6 illustrates exemplary diagrams for performing two-level channel access before occupying the resource to avoid intra-RAT collision for SU in accordance with embodiments of the current invention. In one embodiment, multiple CPE starting position are configured within a symbol for sensing slot level channel to better avoid intra-cell collision outside a channel occupancy time (COT). In the case that the secondary usage is sidelink technology, the channel access/sensing can be performed by the secondary UE on multiple channels. In this case, the control signal can be (pre-)configured to be transmitted on the sub-channel. For example, the control signal can be (pre-)configured on a fixed sub-channel or on each sub-channel.

For sidelink operated in the unlicensed spectrum, the following two operations (Mode 1 operation and Mode 2 operation) are proposed in this disclosure. For mode 1 operation, there is no need of SCI sensing, i.e., up to gNB scheduling on the SL resource. However, LBT sensing is necessary at UE side. It means that the resource selection/reservation at gNB is decoupled with LBT sensing at UE. Essentially, there is the timeline impact due to the introduction of the LBT sensing depending on the reserved or non-reserved transmission. For the transmission on the non-reserved resources, e.g., the first transmission of the periodic traffic or the initial transmission of the aperiodic traffic, the resource selection/reservation at gNB should leave the additional time by considering the LBT time at UE in addition to the existing processing time. Thus, there may be the impact on the timeline for Mode-1 operation. Moreover, LBT related info (e.g., maximum LBT time) may need to be known by gNB to proper resource allocation. For the transmission on the reserved resources, gNB may need to leave the sufficient/no gap between the reserved resources during the resource selection for the potential LBT operation. Thus, it may also require some LBT related information at gNB reported by UE for the proper resource selection to avoid invalid resource allocation.

For mode 2 operation, SCI sensing for resource reservation and LBT sensing happened at the same UE. Thus, LBT info (e.g., LBT access type, CW adjustment) can be available at the device. Similar to the Mode 1 operation, there can be some timeline impact for Mode 2 sensing/selection mechanism depending on the traffic. For the transmission on the non-reserved resources, e.g., the first transmission of the periodic traffic or the initial transmission of the aperiodic traffic, the UE may perform LBT at first and then determine the selection window for resource selection based on the LBT success time. In this case, it is possible that there is a gap between LBT success occasion, and the resource selected for transmission. This can be handled by deferred sensing or

CP extension to handle the gap. Determination of the starting point of the selection window according to the LBT success occasion can avoid the invalid resource selection. Alternatively, the UE may perform resource selection at first and then perform LBT. In this case, the starting point of the resource selection window should consider the LBT operation time in addition to the processing time T1. For the transmission on the reserved resources, the UE may have to determine the time for LBT operation according to the occasion of the reserved resource for transmission. That is, LBT operation is performed up to the reserved resource (i.e., performed some time earlier than the reserved resource for transmission) considering LBT counter and potential LBT failure. In one embodiment, sensing slot level channel access together with multiple CPE starting positions can better avoid intra-cell collision outside a COT. UE1, with transmission 610, and UE2, with transmission 620, both perform type-1 channel access 611 and 621, respectively. Both type-1 CA succeeded. A defer duration 612 and 622 for UE1 and UE2, respectively. Following the LBT procedure, subsequently, a short LBT 613 and 623 are performed for UE1 and UE2, respectively. As shown, both LBT 613 and 623 succeeded. Without a sensing slot level channel access following the successful LBT, intra-cell collision will occur for the UE1 and UE2. In one embodiment, a first symbol of the 14-symbol slot 601 is used for sensing slot level channel access.

In one embodiment 602, the first seven slot are used for slot level channel access. In one embodiment, multiple length CPE is configured, which is transmitted after sensing slot. In one embodiment, the UE selects a CPE from the multiple configured CPEs and performs the channel access. The UE selects the CPE randomly and/or based on one or more preconfigured conditions including a frequency range of the transceiving resources, a numerology, a channel busy ratio, feedback information, a traffic type of the SU transceiving, a traffic priority of the SU transceiving, a channel access priority class (CAPC) of the SU transceiving, PQI and 5Q1. In another embodiment, CPE selection is determined by the network. In yet another embodiment, the UE select a sensing slot length for the channel access. The UE selects the sensing slot length randomly and/or based the preconfigured conditions as above. In one embodiment, the CPE and the sensing slot length are configured independently. In another embodiment, either a CPE or a sensing slot length is configured and the other parameter is derived based on the configured CPE or sensing slot length. As an example, UE1 is configured with a larger CPE 616 or a shorter length sensing slot 615 (compared with sensing slot 625). Channel access with sensing slot 615 for UE1 succeeded, while channel access for UE2 failed. UE1 performs transmission 617 and UE2 does not transmit and waits for the next available resource. UE2 has no transmission (627) following the failed channel sensing at 625.

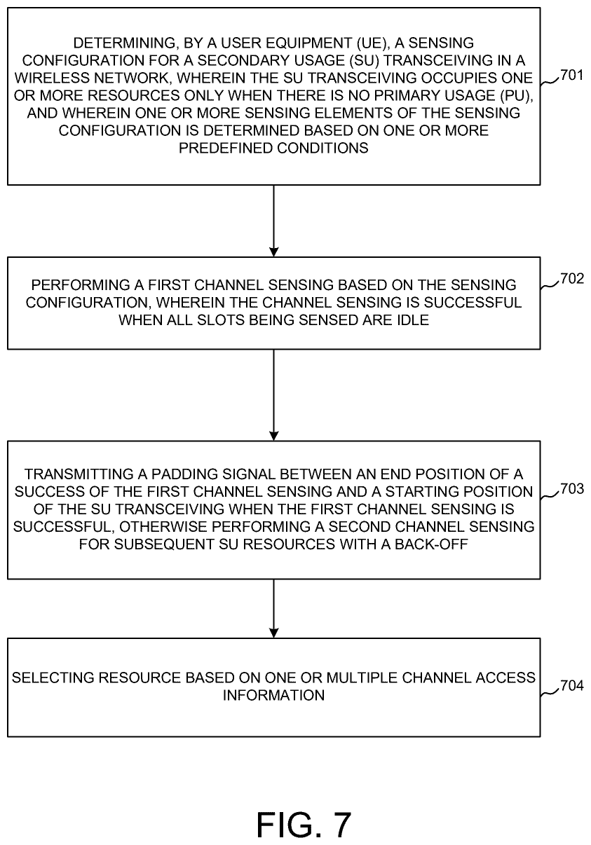

FIG. 7 illustrates an exemplary flow chart for the co-channel coexistence procedure for the SU UE in accordance with embodiments of the current invention. At step 701, the UE determines a sensing configuration for a secondary usage (SU) transceiving in a wireless network, wherein the SU transceiving occupies one or more resources only when there is no primary usage (PU), and wherein one or more sensing elements of the sensing configuration is determined based on one or more predefined conditions. At step 702, the UE performs a first channel sensing based on the sensing configuration, wherein the channel sensing is successful when all slots being sensed are idle. At step 703, the UE transmits a padding signal between an end position of a success of the first channel sensing and a starting position of the SU transceiving when the first channel sensing is successful, otherwise performing a second channel sensing for subsequent SU resources with a back-off. At step 704, the UE selects resource based on one or multiple channel access information.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
determining, by a user equipment (UE), a sensing configuration for a secondary usage (SU) transceiving in a wireless network, wherein the SU transceiving occupies one or more resources only when there is no primary usage (PU), and wherein one or more sensing elements of the sensing configuration is determined based on one or more predefined conditions;
performing a first channel sensing based on the sensing configuration, wherein the channel sensing is successful when all slots being sensed are idle; and
transmitting a padding signal between an end position of a success of the first channel sensing and a starting position of the SU transceiving when the first channel sensing is successful, otherwise performing a second channel sensing for subsequent SU resources with a back-off; and
selecting resource based on one or multiple channel access information.

2. The method of claim 1, wherein the sensing configuration including one or more sensing elements comprising: a channel access procedure starting location, a channel accessing procedure duration, a number of sensing slots for channel sensing, and an offset between a beginning of the channel access procedure starting location and a triggering position of the channel sensing.

3. The method of claim 2, wherein one or more of the sensing elements is configured by the wireless network.

4. The method of claim 2, wherein one or more of the sensing elements is generated by the UE.

5. The method of claim 2, wherein the one or more predefined conditions comprise a frequency range of the transceiving resources, a numerology, a channel busy ratio, feedback information, a traffic type of the SU transceiving, a resource reservation information, a traffic priority of the SU transceiving, a channel access priority class (CAPC) of the SU transceiving, a 5G QoS identifier (5Q1), and a PC5 QoS identifier (PQI).

6. The method of claim 2, wherein one or more sensing elements is determined based on corresponding sensing element range.

7. The method of claim 6, wherein the one or more sensing element range is configured by the wireless network or generated by the UE based on the one or more predefined conditions.

8. The method of claim 2, further comprising: reserving one or more future SU resources upon the success of the first channel sensing; and transmitting a control message to other SU resource users indicating reservation information for the one or more future SU resources.

9. The method of claim 8, wherein the channel sensing configuration is determined based on reservation information, wherein the reservation information including SU resource reservations by the UE and by one or more other UEs.

10. The method of claim 9, wherein one or more predefined conditions for a SU resource includes the reservation information of the SU resource, and wherein a random sensing configuration is determined when there is no reservation on the SU resource, a prioritized sensing configuration is determined when the SU resource is reserved by the UE, and a de-prioritized sensing configuration is determined when the SU resource is reserved by one or more other UEs.

11. The method of claim 10, wherein the prioritized sensing configuration configures a smaller number of sensing slots, a smaller value of offset and prioritized selection of specific resource(s).

12. The method of claim 10, wherein the de-prioritized sensing configuration configures a larger number of sensing slots, a larger value of offset and de-prioritized selection of specific resource(s).

13. The method of claim 1, wherein the padding signal is a cyclic prefix (CP) extension (CPE) or timing advance (TA).

14. The method of claim 1, wherein the determining of sensing configuration involves selecting a CPE starting position from a set of predefined CPE starting positions.

15. The method of claim 1, wherein the SU is for sidelink (SL) transceiving, and wherein the UE performs channel sensing on multiple channels.

16. The method of claim 1, further comprising determining one or more resources are SU resources based on a predefined configuration or a message indication, and wherein a resource is configured to be a resource type comprising a PU resource, an SU resource, and a flexible resource.

17. The method of claim 1, wherein the channel access information comprising CAPC value, contention window size, random back-off counter, expected channel access duration, and channel access result.

18. The method of claim 1, wherein an SU resource is selected as a non-reserved resource based on an channel access duration to determine a starting position of a selection window, and wherein the non-reserved resource is for a first transmission of the periodic traffic or an initial transmission of an aperiodic traffic selected by gNB in Mode 1 or UE in Mode 2.

19. The method of claim 1, wherein an SU is selected as a reserved resource based on one or more elements comprising a location of reserved resource, an expected channel access duration, and a gap offset to determine the trigger position of channel access procedures, and wherein the reserved resource is for a non-first transmission of a periodic traffic or a re-transmission of an aperiodic traffic selected by gNB in Mode 1 or UE in Mode 2.

20. A user equipment (UE), comprising:
a transceiver that transmits and receives radio frequency (RF) signal in a wireless network;
a configuration module that determines a sensing configuration for a secondary usage (SU) transceiving in a wireless network, wherein the SU transceiving occupies one or more resources only when there is no primary usage (PU), and wherein one or more sensing elements of the sensing configuration is determined based on one or more predefined conditions;
a sensing module that performs a first channel sensing based on the sensing configuration, wherein the channel sensing is successful when all slots being sensed are idle; and
a control module that transmits a filler signal between an end position of a success of the first channel sensing and a starting position of the SU transceiving when the first channel sensing is successful, otherwise performs a second channel sensing for subsequent SU resources with a back-off.

21. The UE of claim 20, wherein the sensing configuration including one or more sensing elements comprising: a channel access procedure starting location, a channel accessing procedure duration, a number of sensing slots for channel sensing, and an offset between a beginning of the channel access procedure starting location and a triggering position of the channel sensing.

22. The UE of claim 20, wherein the one or more predefined conditions comprise a frequency range of the transceiving resources, a numerology, a channel busy ratio, feedback information, a traffic type of the SU transceiving, a traffic priority of the SU transceiving, a reservation information, a channel access priority class (CAPC) of the SU transceiving, a 5G QoS identifier (5QI), and a PC5 QoS identifier (PQI).

23. The UE of claim 20, wherein the control module further reserves one or more future SU resources upon the success of the first channel sensing; and transmits a control message to other SU resource users indicating reservation information for the one or more future SU resources.

24. The UE of claim 23, wherein the channel sensing configuration is determined based on reservation information, wherein the reservation information including SU resource reservations by the UE and by one or more other UEs.

25. The UE of claim 24, wherein one or more predefined conditions for a SU resource includes the reservation information of the SU resource, and wherein a random sensing configuration is determined when there is no reservation on the SU resource, a prioritized sensing configuration is determined when the SU resource is reserved by the UE, and a de-prioritized sensing configuration is determined when the SU resource is reserved by one or more other UEs.
